(19) United States
(12) Patent Application Publication
(10) Pub. No.: US 2017/0237700 A1
(43) Pub. Date: Aug. 17, 2017

(54) Photo-sharing or exposure enabling social networking system.

(71) Applicant: Ishaaq Azeez Rahaman, Queens, NY (US)

(72) Inventor: Ishaaq Azeez Rahaman, Queens, NY (US)

(21) Appl. No.: 15/046,098

(22) Filed: Feb. 17, 2016

(51) Int. Cl. H04L 12/58; G06Q 30/02; G06Q 50/00; G06F 17/30

(52) U.S. Cl. CPC H04L 51/32; G06F 17/30882; G06F 17/30867; G06Q 30/0261; G06Q 50/01

(57) ABSTRACT

This is a novel system and method(s) that provides a means for a social networking site by utilizing a photograph and posting the photograph on a storefront window or any window that can be posted on. The photograph may depict a user. The photograph may have a link displayed on it or near it. When the link is scanned with a personal mobile device, the link will connect our website to the personal mobile device. Now, content from our website will be displayed on the personal mobile device's screen. The content may be a digital image of the photograph that is posted on the storefront window. We also utilize exposure. We believe that when a human gains exposure then their exposure may help them achieve fame.

### FIELD OF INVENTION

The disclosure relates to a system and methods for social networking using digital and analog elements.

### BACKGROUND—PRIOR ART

The following is a tabulation of some prior art that presently appears relevent.

### U.S. Patent References

| Pat. No. | Issues Date | Patentee |
|---|---|---|
| 7,881,702 | February 2011 | Heyworth, et al. |
| 9,135,208 | September 2015 | Huang, et al. |
| 8,010,459 | August 2011 | Buyukkokten, et al. |
| 7,603,292 | October 2009 | Bragg, et al. |
| 8,856,229 | October 2014 | Ramamurthy, et al. |
| 9,197,592 | November 2015 | Honjou, et al. |
| 8,455,805 | June 2013 | Hall |
| 8,500,026 | August 2013 | Fan, et al. |
| 8,550,351 | October 2013 | Sun, et al. |
| 9,235,371 | January 2016 | Kamath, et al. |

### Nonpatent Literature Documents

Firestone, Lisa. (2012, November). Is Social Media to Blame For the Rise In Narcissism? [Blog post]. Retrieved from https://www.psychologytoday.com/blog/compassion-matters/201211/is-social-media-blame-the-rise-in-narcissism
Sassman, Brooke. (2015, November). The number of hours that teens are spending on smartphones may surprise you. Retrieved from http://www.today.com/health/number-hours-teens-are-spending-smartphones-may-surprise-you-t53651
Cane, Clay. (2013, June) Brittany Howard of the Alabama Shakes: “I Don't Think About Color”. Retrieved from http://www.bet.com/news/music/2013/06/25/brittany-howard-of-the-alabama-shakes-i-don-t-think-about-color.html
(2015, October). The trust machine. The Economist. 417 (8962), 13.
(2015, December). India's Diamond Polishers. Hard faces. The Economist, 417(8967), 40-41.
(2015, December). Narcissistic Personality Disorder. Retrieved from https://www.pschologytoday.com/conditions/narcissistic-personality-disorder
Lyon, Lindsay. (2009, April). Narcissism Epidemic: Why There Are So Many Narcissists Now. Retrieved from http://health.usnews.com/health-news/family-health/brain-and-behavior/articles/2009/0421/narcissism-epidemic-why-there-are-so-many-narcissists-now Goldberg, Joseph. (2015, March). Retrieved from http://www.webmd.com/mental-health/narcissistic-personality-disorder
Wikipedia, the free encyclopedia. Gestell. Retrieved from https://en.wikiedia.org/wiki/Gestell
Wikipedia, the free encyclopedia. Existentialism. Retrieved from https://en.wikipedia.org/wiki/Existentialism
Wikipedia, the free encyclopedia. Martin Heidegger. Retrieved from https://en.wikipedia.or/wiki/Martin_Heideaer

We believe there are many humans that would like to post a photograph that depicts them on a storefront window, or any window, or door, whereby a multitude of other humans may see the photo. We believe this because many humans already post photos that depict them on places where a multitude of other humans may see the photo. In the prior art, these places are usually on websites or social networking sites.

Humans have remarkable creativity, even ordinary humans. Humans have a fundamental need for creative work, which is not being met in systems where humans are like cogs in a machine. An example of such a system, and one found in almost every city in the world, would be a store-to-customer system in which a store sells products or services to a customer. The store will sell the customer a product or service, then give the customer a receipt and then the customer is summarily dismissed so that the store can deal with the following customer; or maybe the store will offer a gift or a coupon to the customer but this is rare and often the “gift” has a catch to it. For example, the customer must first spend four hundred dollars before November 25 to be eligible for the gift, which may be a turkey. Systems such as this offer very little for customers or humans to express their creativity. These systems allow stores to treat humans like cogs in a machine.

Many existing social networks provide a system for humans to feel narcissistic or to play a game or share information or photographs. Many existing social networks consist of digital elements. Many social networks mine information from humans that use their social networks. Also, many social networks allow other companies to mine information from humans, and then those companies find effective ways to advertise or sell products or services to humans. Therefore, this information has immense value to many social networks and to many companies. Unfortunately, humans are giving away this valuable information to the social networks or companies with very little—if anything at all—being given back to them. In other words, many social networks are treating humans like cogs in a machine. When we say “cogs in a machine” we mean that many systems consist of and depend on human activity in order to gain assets. However, these systems give very little assets back—if any at all—to the humans that use their systems.

We will now discuss several aspects of social networks, narcissism and self-esteem. Mark Zuckerberg's FACEBOOK.com or FACEBOOK is an example of a social network. It is a social network where the users share a multitude of photographs that depict themselves. “Psychology researcher Soraya Mehdizadeh at York University in Toronto, conducted a study, published in the journal Cyberpsychology, Behavior and Social Networking of 100 FACEBOOK users and measured activities such as photo sharing, wall postings and status updates and frequency and duration of use. After measuring each subject using the Narcissism Personality Inventory and Rosenberg Self-Esteem Scale, Mehdizadeh discovered that narcissists and people with lower self-esteem were more likely to spend more than an hour a day on FACEBOOK and were more prone to post self-promotional photos and showcase themselves through status updates and wall activity.

So it seems like the jury is still out about the relative impact—positive or negative—of social media such as FACEBOOK, particularly for young people, although there is mounting evidence to show a link with narcissism.”

“The researchers concluded that the people who used FACEBOOK the most tended to have narcissistic or insecure personalities.”

This excerpt states that there is mounting evidence to show a link between narcissism and social media (social networks).

Furthermore, “Self-esteem differs from narcissism in that it represents an attitude built on accomplishments we've mastered, values we've adhered to, and care we've shown toward others. Narcissism, conversely, is often based on a fear of failure or weakness, a focus on one's self, an unhealthy drive to be seen as the best, and a deep-seated insecurity and underlying feeling of inadequacy.”

If narcissism has a negative impact on humans, and we help develop narcissism for our users, we can still prove that doing this (developing narcissism) has commercial value. Our system and methods have commercial value because what we provide is novel, and it uses different elements then the prior art uses, and it solves a longfelt but unsolved need, and it produces unexpected results. We will discuss how we accomplish this below.

We believe that if narcissism is bad for human health, then it still has commercial value and thus, is profitable. We believe this because smoking tobacco is bad for human health and yet, it is profitable. In fact, it is extremely profitable for the companies that sell tobacco. The difference is that tobacco is a physical product while narcissism is not. However, there is a disorder called narcissistic personality disorder (NPD) for humans. “Narcissism is a less extreme version of Narcissistic Personality Disorder. Narcissism involves cockiness, manipulativeness, selfishness, power motives, and vanity—a love of mirrors.”

“It's human nature to be selfish and boastful now and then, but true narcissists take it to an extreme. They don't just have extra self-confidence, they don't value others' feelings or ideas and ignore others' needs. But there's a difference between being self-absorbed, often called a narcissist, and having narcissistic personality disorder, which is a mental illness.”

Also, “ . . . when we did a study a couple years ago finding that narcissism was increasing substantially among a nationwide sample of college students. We compared that effect to the obesity epidemic, and we found that the rise in narcissism was just as big as the rise in obesity in adults. That got us thinking: If obesity is an epidemic, then we may have an epidemic of narcissism on our hands. This past summer [a study of] a nationally representative sample of 35,000 Americans found that 6 percent of Americans, or 1 out of 16, had experienced [clinical narcissistic personality disorder (NPD)] at some point in their lives. And there was a big generational effect. You'd expect that people who are older would have a higher percentage of having experienced this because they've lived so many more years. But only 3 percent of people over 65 had had any experience with NPD, compared with almost 10 percent of people in their 20s. Given that you can only diagnose this when someone is 18, that's a pretty short number of years in which to have this experience. That was another pretty big indication that this was an out-of-control epidemic.”

Furthermore, diseases and disorders may have different origins or etiologies (physical and mental, respectively), but they both still have physical characteristics or behaviors that are observable. Therefore, if these physical characteristics or behaviors are observable then they are also quantifiable or able to be measured. In other words, humans can only see narcissism if it is physically demonstrated by speech, action, or written words. An example would be a woman standing to the side on a sidewalk. The woman stares at the crowds of humans passing by her for a minute and then she goes home. This woman would not be called a narcissist because she demonstrated no physical signs (or behavior) that met the signs and symptoms of narcissism.

In another example, a man is standing in the middle of the sidewalk, holding a mirror and a smartphone in his hands. He states how handsome and smart he is repeatedly. He is speaking loud enough for other humans to hear him as he blocks their path. He also states he is very important and has a very high position at his job even though he just started working there as an intem. This man demonstrated physical signs (or behavior) that met the signs and symptoms of narcissism. Those signs and symptoms are: an inflated sense of their own importance, a deep need of admiration, and a lack of empathy for others. These signs and symptoms can be seen by other humans. Therefore, we believe narcissism demonstrated by humans (or narcissists) is quantifiable or able to be measured. Furthermore, as we noted above, narcissism is rising in the USA. One reason for this rise is because social networking sites are very popular and many humans post photos of themselves on these sites. This is why we believe we may commercialize narcissism. We are not saying we will sell narcissistic behavior as if it were a product or service. Also, we are not encouraging extreme narcissism or NPD. However, we do provide a novel system and methods that narcissists would enjoy using. We believe this because narcissists enjoy posting photographs of themselves on places where a multitude of humans may see them. Our system and methods uses elements whereby users may post photographs on places where a multitude of humans may see them. Our elements are different than the elements of the prior art.

“New research has found that teens are spending a reported nine hours on media consumption, with tweens trailing not too far behind, dedicating an estimated six hours to their smartphones or tablets. Communicating and creating are among the greatest uses for digital screen media.”

Many narcissists do not want to change there narcissistic ways. Infact, many of them may want to increase their narcissistic behavior. Many humans who exhibit narcissism or have NPD, do so for many years. Also, as mentioned above, humans are behaving more narcissistic in the USA. These narcissists want to act more narcissistic which means they would use our system and methods. It is also known that many narcissists enjoy spending money; thus, a novel system and methods that narcissists would enjoy using has commercial value.

We will now discuss several aspects of trust. We believe that trust is a key element for business to occur. A digital asset that many humans use is called BITCOIN, which was invented by Satoshi Nakamoto. “BITCOIN has a bad reputation. The centralized digital cryptocurrency, powered by a vast computer network, is notorious for the wild fluctuations in its value, the zeal of its supporters and its degenerate uses . . . . This is unfair. The value of the BITCOIN has been pretty stable, at around $250, for most of this year . . . and skepticism has given way to enthusiasm (the European Union recently recognized it as a currency). But most unfair of all is that BITCOIN's shady image causes people to overlook the extraordinary potential of the “blockchain”, the technology that underpins it. This innovation carries a significance far beyond cryptocurrency. The blockchain lets people who have no particular confidence in eachother collaborate without having to go through a neutral central authority. Simply put, it is a machine for creating trust.

The blockchain is an even more potent technology. In essence it is a shared, trusted, public ledger that everyone can inspect . . . .

BITCOINs itself may never be more than a curiosity. However, blockchains have a host of other uses because they meet the need of a trustworthy record, something vital for transactions of every sort.

The real innovation is not the digital coins themselves, but the trust machine that mints them—and which promises much more besides.”

Thus, if humans trust a business platform (e.g. BITCOIN or blockchain technology) then they will now spend money on that business platform more frequently; or by extension, if humans trust a store then they will now spend money at that store; but if humans don't trust a store then they will not spend money at that store. This is relevent to our cause because we claim that our system and methods help humans develop trust. Also, BITCOIN or blockchain technology uses digital elements “for creating trust” in the form of algorithms or cryptocurrency. Our system and methods uses digital and analog elements for developing trust.

Another example of how trust is a key element for business to occur is found in the diamond industry. “Nine-tenths of the world's natural diamonds pass through the Indian state of Gujurat, where in and around the city of Surat they are cut and polished before being sold . . . men lounge on pillion seats and handcarts, passing around open packets of rocks worth several years' salary. The trust embodied in this form of community is astounding—and essential to their trade.”

The is relevent to our cause because it is an example of how trust between two or more humans allows business to occur. In this example we may conclude that if trust was not present in the diamond polishers of Surat, than nine-tenths of the world's natural diamonds would not pass through Surat. We may now assume that diamond mining companies around the world would not send their rough diamonds to Surat if those mining companies did not trust the diamond polishers and cutters of Surat. An excerpt from the example proves this. It states “The trust embodied in this form of community is astounding—and essential to their trade.” Therefore, trust between the diamond mining companies (or stores) and the diamond polishers or cutters of Surat is a key element for business to occur. Also, trust amongst the diamond polishers or cutters themselves is a key element for business to occur.

However, diamonds do not develop trust. It is the community in Surat that develops trust because the diamond cutters or polishers are trustworthy. We used the diamond industry in Surat as an example to show how trust enables a lot of business to occur. Therefore, developing trust in humans can be very profitable.

When compared to the prior art such as FACEBOOK, we are able to bring forth results that are unexpected. FACEBOOK does not enable humans to develop narcissism as efficiently as we do. Therefore, we may help humans develop more narcissism then FACEBOOK does. FACEBOOK does not enable stores, store managers, or event promoters to exhibit good customer service as efficiently as we do. Therefore, we may help humans exhibit good customer service better than FACEBOOK does. FACEBOOK does not help humans gain exposure as efficiently as we do. Our users may post their photos on storefront windows (analog) as well as on a website (digital). Therefore, we may help humans gain more exposure than FACEBOOK does.

However, this author has seen prior art from FACEBOOK that we believe is relevent to our cause. The author saw a poster that was posted on a storefront window. The poster depicted a beautiful female model. The storefront window belonged to a beauty salon. There was a link or QR code posted on the poster. The poster asked humans to “follow us on FACEBOOK”, wherein “us” is the beauty salon. The poster also asked humans to use a personal mobile device to scan the QR code (the personal mobile device would first need to have a mobile application that allows it to scan QR codes). Then the QR code would connect the personal mobile device to a FACEBOOK webpage. Then, content from the FACEBOOK webpage would be displayed on the mobile device's screen.

However, this does not negate the patentability of our system and methods for several reasons. One reason is that the poster did not depict the human who posted the poster on the storefront window. The content in the poster is significant because in our system and methods the content in the photograph may depict the human who posted the photograph on the storefront window. Also, the content in the photograph will depict something or someone that the user chooses to display in their photograph. This is a significant difference because any human who uses our system and methods will have a more personal connection or affiliation with the photograph they posted.

Furthermore, in the prior art, we know that their poster was not posted on the window by the human depicted in the poster because the human was a professional model wearing beauty products. Some of the beauty products were nail polish, make-up, or a special hair-style that a beauty salon generally offers.

When the human posts the photo on the storefront window and the photo depicts the human, this brings about many unexpected results that the prior art example does not. In our system, the human may be someone that passes by the store every day. Thus, the human may wish to interact (e.g. scan the link) with their photo on the storefront window frequently. The human may also want to go inside the store and communicate with the store manager or store employees more frequently because their photo is posted on the storefront window. This may lead the human to buy more products or services from the store.

In the prior art, they use a professional model in their posters. Many of these models are stock photo models. We don't use stock photo models in our photos. This is a significant difference. The humans in our photos take or develop the photos themselves and choose which store to post their photo on. In the prior art, their stock photo model does not take or develop the photos themselves and choose which store to post their photo on. Infact, their stock photo model may not even know that a poster with their depiction is posted on that particular beauty salon. In our system, humans will have the control or the option to choose which type of content they want to display in their photo. They also have the control or the option to choose which store to post their photo on. In the prior art, the human in the poster is a stock photo model. Stock photo models take a multitude of photos for stock photo distributors who buy the rights to these photos. Thus, it is the stock photo distributors that have the control of the photos and use them in any way they see fit. The stock photo distributors may sell the photos to other companies who may in turn put the photo of the model on a poster and then sell the poster to a beauty salon or to some other company. Thus, in the prior art, the stock photo model may have never been to that particular beauty salon but nevertheless, a poster with their depiction is posted on the window of that salon.

Also, the stock photo model did not personally take the photo, or print the photo, or post the QR code on the photo, or ask the store manager for consent to post the photo, or physically post the photo on the window of the beauty salon. In our system, the human in the photo may accomplish all of these things themselves. This is a significant difference between our system and the prior art.

In our system, the human is aware that their photo is posted on a storefront window because they posted it there. Hence, in our system the human depicted in the photo has a more significant role with what happens to the photo.

In the prior art, when a human uses a personal mobile device to scan the QR code on the poster, content from a FACEBOOK webpage will be displayed on their mobile device's screen. The stock photo model depicted in the poster did not choose or control the content displayed on the FACEBOOK webpage. Instead, the content displayed on the FACEBOOK webpage is controlled or chosen by the beauty salon.

However, in our system, the content displayed on the mobile device's screen pertains to the human depicted in the photo. Also, in our system the content displayed on our website pertains to the human depicted in the photo. Thus, in our system, after scanning the link or QR code, a human's personal mobile device will connect to their webpage at our website, not to the store's FACEBOOK webpage. In our system, the analog photograph depicts content that the user chooses. This content may depict the user himself or herself. Also, in our system, the webpage that the link connects to, displays content that the user chooses. Thus, there are analog and digital elements in our system, and the user has control over these analog and digital elements.

We will now discuss several aspects of fame and what humans do with it The famous music mogul JAY-Z once said: “Fame is the most addictive drug in the world.” We believe that a multitude of humans (or narcissists) want to achieve fame. There is evidence showing that many users in a social network are narcissists. Fame may be addictive for a multitude of humans because a multitude of humans are narcissistic.

We believe that there is a longfelt but unsolved need for humans to achieve fame. Many humans want to achieve fame even if it is just a small amount of fame. Some humans want to achieve fame for a temporary period only. Many humans work hard to achieve fame. Many humans utilize fame to achieve a multitude of goals. One example of this are humans who run in a marathon in order to bring attention or fame to a particular cause. Humans know that the more fame their cause receives then the more likely it is for their cause to receive financial assets or be victorious. Many humans would even go to extreme measures to achieve fame. One example of an extreme measure is a hunger strike. Many humans go on hunger strikes because it is an effective method of bringing fame to their cause. Another extreme measure is climbing a very tall, dangerous mountain in order to bring fame to a cause. Another example of fame being used to achieve a goal are humans who want to become professional models or actors or singers. They know that if they achieve fame then they may be successful or receive financial assets. Some of these humans will then use social networks or websites to promote their modelling, acting, or singing skills so that they may achieve fame. Another example of fame being used to achieve a goal is when politicians campaign for office. Politicians will appear on television commercials or internet advertisements because they know that this will bring them more fame. The fame may bring them more votes or financial assets. A final example of fame being used to achieve a goal is when companies hire famous humans to advertise for them. For example, a watch company may hire a famous soccer player to advertise for them. The watch company knows that many of the famous soccer player's fans will now buy their watches and thus, the watch company may gain financial assets. Hence, for all the reasons declared above, fame may be used to achieve a multitude of goals. Thus, many humans want to achieve fame.

Furthermore, posting photos on storefront windows in New York City is legal to do. We believe it is legal to do this in a multitude of other cities as well. In many cities there are many storefront windows without any photographs posted on them. These windows look boring, simple, or mundane to many humans passing by the store. We believe there is a longfelt but unsolved need in which humans want to be seen by a multitude of other humans. We believe there is commercial value for posting photographs with links on storefront windows.

### Advantages

Accordingly, several advantages of one or more aspects are as follows: to utilize human traits such as narcissism, trust, pride, or self-esteem, all of which, many humans place a high value on. Other advantages of one or more aspects are as follows: to utilize affiliation between humans and stores or events and; to utilize communication, and exposure and; to utilize fame, which many humans secretly or openly covet to some degree. We believe that when a human develops fame then their fame may help them gain financial assets or achieve a multitude of goals. Other advantages of one or more aspects are as follows: to provide humans a multitude of methods—using both analog and digital elements—to express their creativity with photographs. Other advantages of one or more aspects are as follows: to make a human (or a cause) more famous, or exposed by using a storefront window, a photograph, a link, a personal mobile device, and a website.

### DRAWINGS—FIGURES

FIG. 1 shows a frontal view of a human and two stores with two storefront windows.

FIG. 2 shows a frontal view of two humans standing in front of two stores with two storefront windows.

FIG. 3 shows a frontal view of a human and two stores with two storefront windows, a photograph depicting the human is posted on a storefront window.

FIG. 4 shows a frontal view of a human holding an object and two stores with two storefront windows; a photograph depicting the human is posted on a storefront window; in the photograph is a smaller box.

FIG. 5 shows a frontal view of two humans and two stores with two storefront windows; there is a smaller box in a storefront window.

FIG. 6 shows a frontal view of four humans, each holding an object; there are two stores and two storefront windows; a photograph depicting a human is posted on a storefront window and a smaller box is in the photograph.

FIG. 7 shows a frontal view of three humans; there are two stores and two storefront windows; a photograph depicting a human is posted on a storefront window.

FIG. 8 shows a frontal view of three humans, each holding an object; there are two stores and two storefront windows; both storefront windows have a photograph posted on them.

### DRAWINGS—REFERENCE NUMERALS

In the drawings, closely related parts have the same number but different alphabetic suffixes.

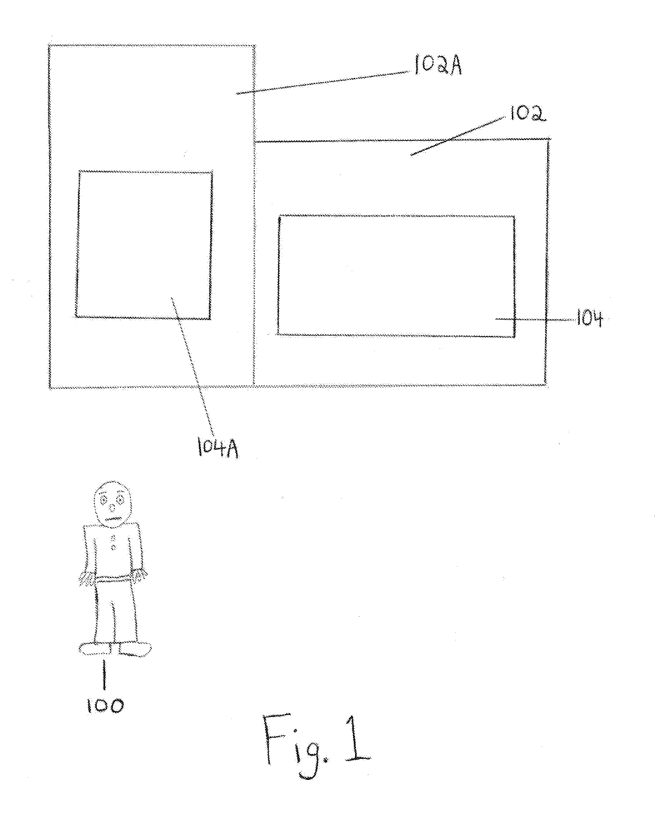

### FIG. 1

100 is a user
102 is a store
102A is another store
104 is a storefront window
104A is another storefront window

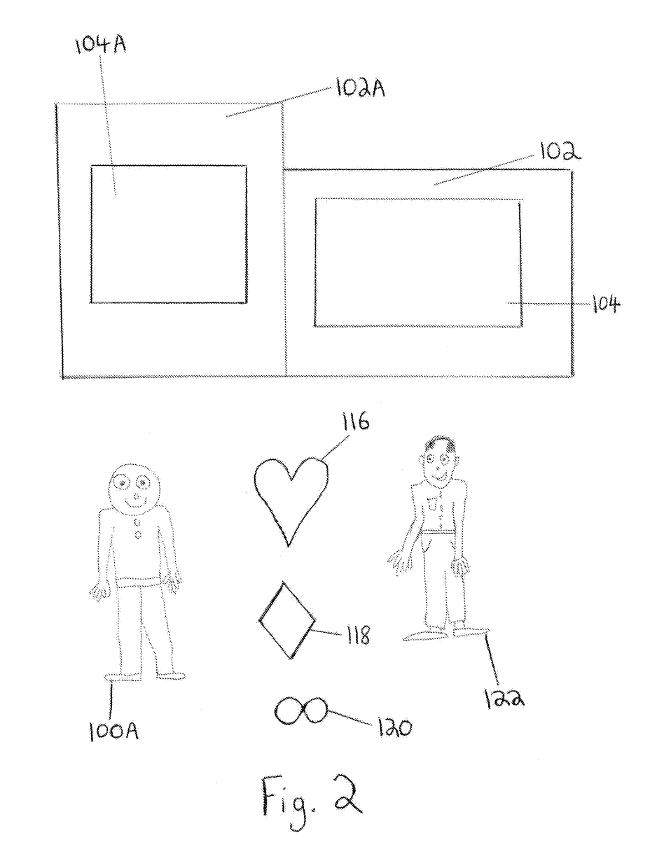

### FIG. 2

100A is a user communicating
102 is a store
102A is another store
104 is a storefront window
104A is another storefront window
116 is a plurality of communication
118 is a plurality of consent
120 is a plurality of selling of consent
122 is a consenter (or a store manager or a store employee)

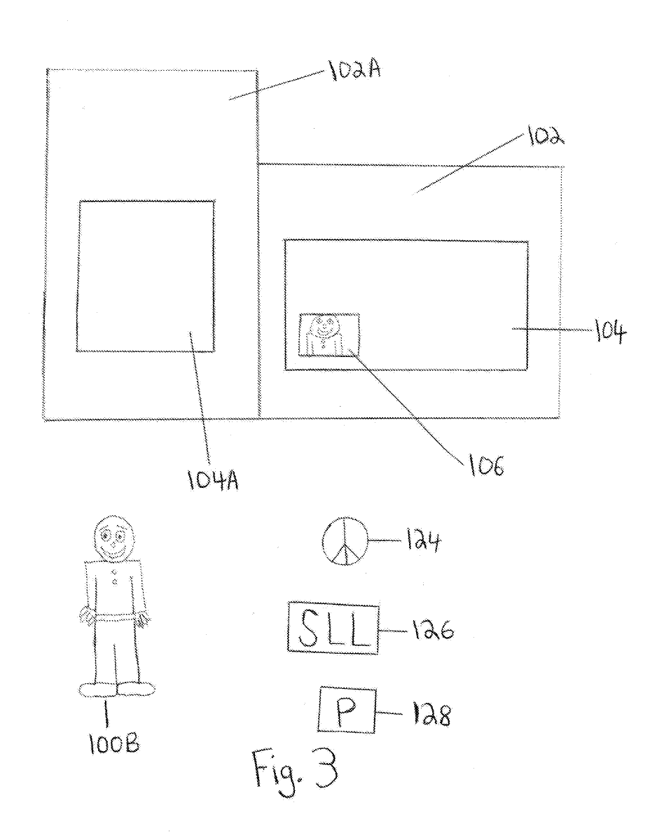

### FIG. 3

100B is a user who is smiling
102 is a store
102A is another store
104 is a storefront window
104A is another storefront window
106 is a photograph which, in this embodiment, is depicting the user
124 is a plurality of trust
126 is a plurality of good customer service
128 is a plurality of pride or self-esteem

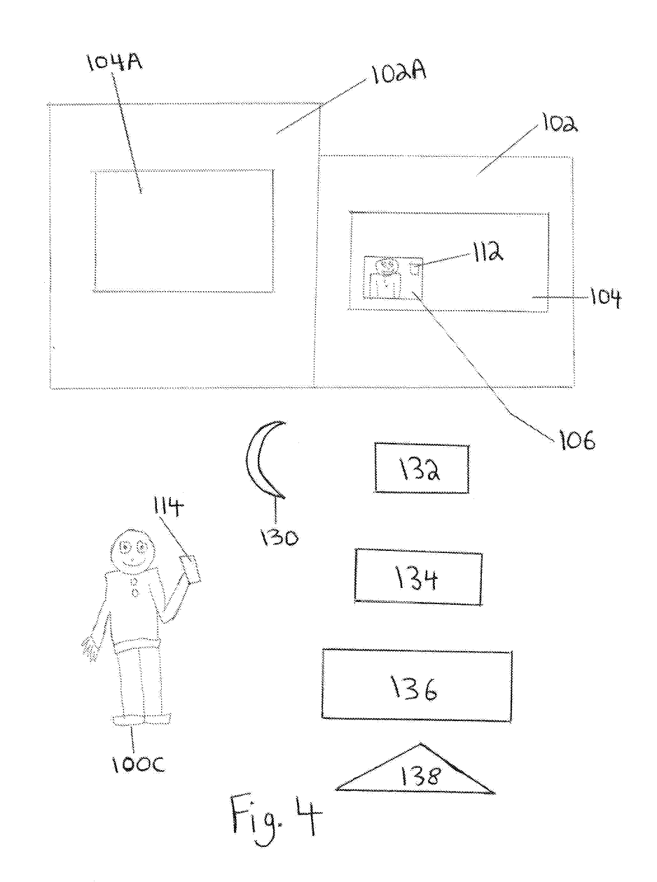

### FIG. 4

100C is the user holding an object and he is smiling
102 is a store
102A is another store
104 is a storefront window
104A is another storefront window
106 is a photograph which, in this embodiment, is depicting the user
112 is a link which, in this embodiment, is a QR code
114 is a personal mobile device
130 is our social network
132 is a digital image file
134 is a webpage
136 is our website
138 is a plurality of internet networks or wireless communication networks

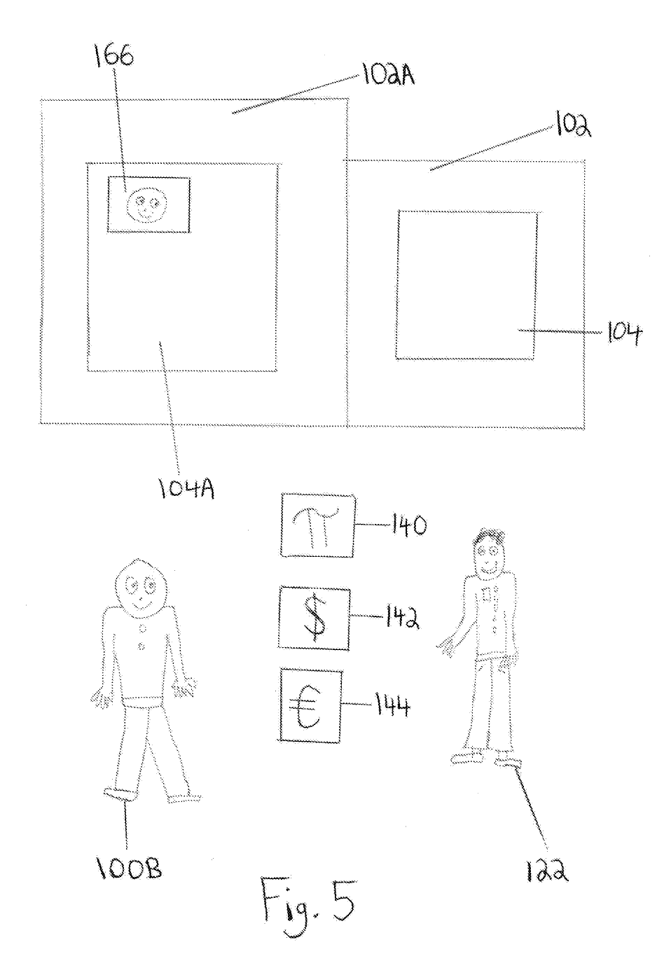

### FIG. 5

100B is a user, who is now smiling
122 is a consenter (or a store manager or a store employee)
102 is a store
102A is another store
104 is a storefront window
104A is another storefront window
140 is a plurality of affiliation
142 is a plurality sales
144 is a plurality of web traffic
166 is a plurality of assets

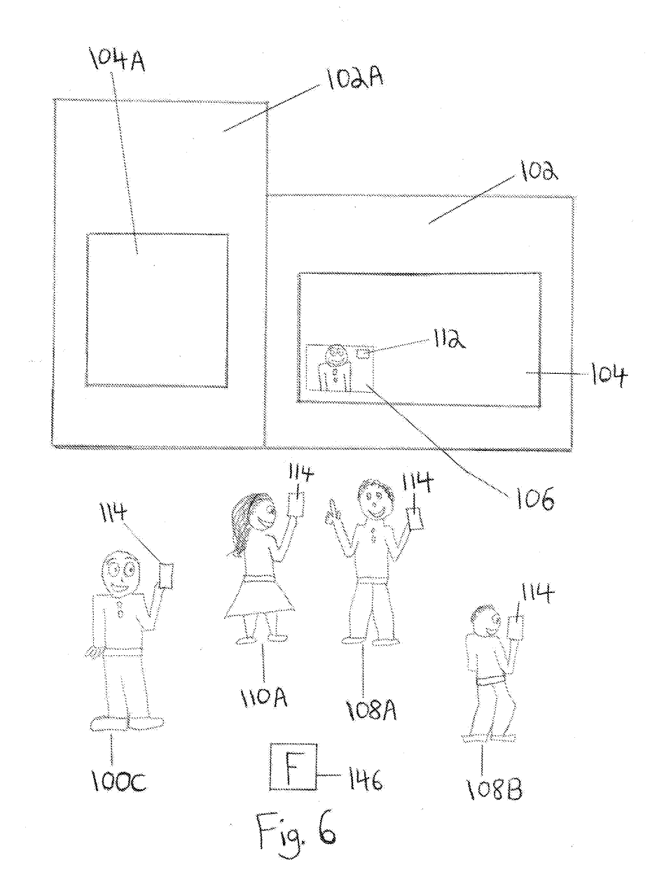

### FIG. 6

### FIG. 6 May be Designated as the OG Figure (Official Gazette)

100C is the user holding an object and he is smiling
102 is a store
102A is another store
104 is a storefront window
104A is another storefront window
106 is a photograph which, in this embodiment, is depicting the user
108A is a male friend holding a personal mobile device
108B is another male friend holding a personal mobile device
110A is a female friend holding a personal mobile device
112 is a link which, in this embodiment, is a QR code
114 is a personal mobile device
146 is a plurality of fame

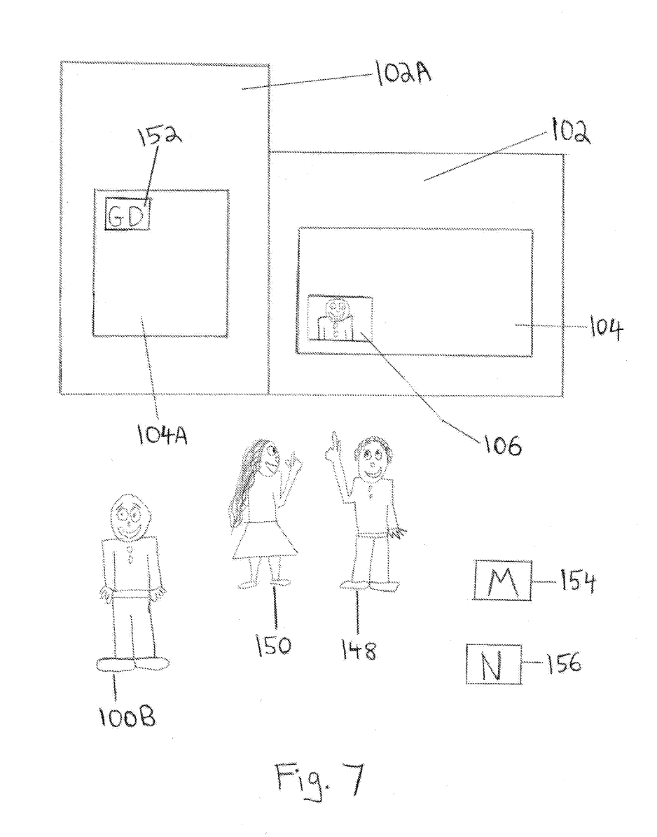

### FIG. 7

100B—is a user, who is now smiling
102—is a store
102A—is another store
104—is a storefront window
104A—is another storefront window
106—is a photograph which, in this embodiment, is depicting the user
148—is a multitude of male humans
150—is a multitude of female humans
152—is a plurality of games
154—is a plurality of customers
156—is a plurality of narcissism or vanity

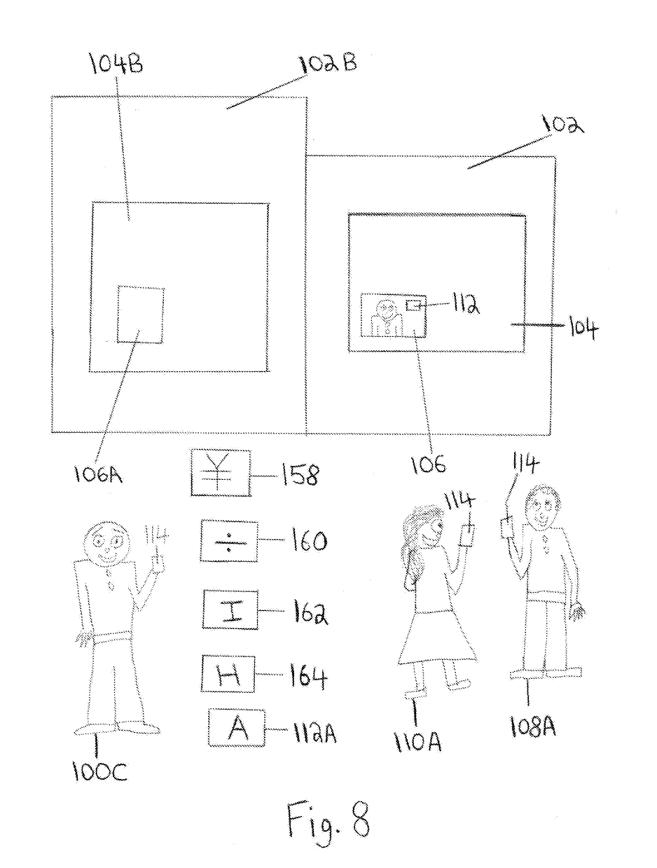

### FIG. 8

100C is the user holding an object and he is smiling
102 is a store
102B is a restaurant
104 is a storefront window
104B is a restaurants storefront window
106 is a photograph which, in this embodiment, is depicting the user
106A is a photograph posted on a restaurant
108A is a male friend holding a personal mobile device
110A is a female friend holding a personal mobile device
112 is a link which, in this embodiment, is a QR code
112A is a plurality of digital links
114 is a personal mobile device
158 is a plurality of gifts or complimentary items
160 is a plurality of thrift
162 is a plurality of information sharing
164 is a plurality of exposure

### DETAILED DESCRIPTION—FIGS. 1-8—FIRST EMBODIMENT

One embodiment of a user 100 illustrated in FIG. 1 is passing by two stores 102 and 102A which both have a storefront window 104 and 104A.

In FIG. 2 a user 100A is now smiling. He is standing by the store 102 or 102A. He was able to develop a plurality of communication 116 with a consenter 122 or a store manager or a store employee and then receive a plurality of consent 118. There may be a plurality of selling of consent 120 if the consenter 122 chooses to sell their consent 118 to the user 100A. There are two storefront windows 104 and 104A. When the consenter 122 sells their consent 118 to the user 100A then the consenter 122 has developed or gained a plurality of assets 166 (see FIG. 5).

In FIG. 3 a user 100B is now smiling. He is standing by two stores 102 and 102A with two storefront windows 104 and 104A. He has achieved a plurality of pride or self-esteem 128 because he was able to obtain a plurality of consent 118 and post a photograph 106, which in this embodiment is depicting the user 100B, on the storefront window 104. The user 100B has also developed a plurality of trust 124 with the consenter 122 because he had communication 116 with the consenter 122 and the consenter 122 gave the user 100B consent 118. After the consenter 122 gave consent 118 to the user 100B to post the photograph 106 on the window 104, the consenter 122 or the store 102 may exhibit a plurality of good customer service 126. When the photo 106 has enabled the store 102 to exhibit good customerer service 126 or the user 100B to develop trust 124 with the consenter 122 then the store 102, or the user 100B, or the consenter 122 has developed or gained a plurality of assets 166 (see FIG. 5).

In FIG. 4, a user 100C is holding a personal mobile device 114. He is standing by two stores 102 and 102A. The photograph 106, which in this embodiment is depicting the user 100C, is posted on the storefront window 104. Furthermore, a link 112 is posted on the photo 106. The user 100C may use the personal mobile device 114 to scan the link 112 which, in this embodiment, is a QR code. Then, content from our website 136 or the user's 10C webpage 134 at our website 136 may be displayed on the personal mobile device's 114 screen.

Furthermore, the user 100C may convert the photo 106 into a digital image file 132 and upload, download, or post the digital image file 132 to their webpage 134 at our website 136. Our website 136 may connect to a plurality of internet networks or wireless communication networks 138. If there are two or more users utilizing our system and methods or our website 136, then a means for our social network 130 may be developed.

In FIG. 5 the user 100B and the consenter 122 are standing in front of two stores 102 and 102A. There are two storefront windows 104 and 104A. The user 100B has now achieved a plurality of affiliation 140 with the store 102 because the photograph 106, which in this embodiment is depicting the user 100B, is posted on the storefront window 104 (see FIG. 3 or FIG. 7 for photo 106). The store 102 may now achieve a plurality of sales 142.

Furthermore, a multitude of friends (not shown) of the user 100B may use our website 136 and see the digital image file 132 of the photo 106. Also the friends of the user 100B may see the store 102 or the storefront window 104 in the photo 106 or the digital image file 132.

After seeing the photo 106, the friends of the user 100B may now shop at the store 102 and thus, the store 102 may achieve sales 142. If there are a multitude of users on our website 136 then our website 136 may develop a plurality of web traffic 144.

When the photo 106 has enabled the store 102 to achieve sales 142 or the website 136 to develop web traffic 144 then the photo 106 has now developed into an asset 166.

In FIG. 6 there are three friends of the user 100C. The three friends are 108A, 108E and 110A. The user 100C and the three friends are each holding a personal mobile device 114. They are all standing in front of two stores 102 and 102A with two storefront windows 104 and 104A. There is a photograph 106 which in this embodiment, is depicting the user 100C and a link 112 posted on the photo 106. The photo 106 is posted on the storefront window 104. The user 100C has now achieved a plurality of fame 146 because a multitude of his friends or other humans may now see the photo 106 on the window 104 or at his webpage 134 at our website 136. Furthermore, the user 100C may upload or post a digital image file 132 of the photo 106 on his webpage 134 at our website 136 whereby the photo 106 may now be seen by a multitude of humans who are using internet networks or wireless communication networks 138.

In FIG. 7 the user 100B is standing with a multitude of male humans 148 or a multitude of female humans 160 infront of two stores 102 and 102A with two storefront windows 104 and 104A. A photograph 106 depicting the user 100B is posted on the storefront window 104. The user 100B has developed a plurality of narcissism or vanity 156 because a multitude of male humans 148 or a multitude of female humans 160 may now see the photo 106 depicting the user 100B on the storefront window 104. If a multitude of male humans 148 or a multitude of female humans 150 use our website 136 then they may see the digital image file 132 of the photo 106; then the user 100B may develop narcissism or vanity 16.

Furthermore, the store 102 may gain a plurality of customers 154 because a multitude of male humans 148 or a multitude of female humans 150 saw the photo 106 depicting the user 100B posted on the window 104 and some of the male humans 148 or female humans 150 may know the user 100B and may now want to go inside the store 102; after going inside the store 102 the male humans 148 or female humans 150 may now want to shop at the store 102 and thus, the store 102 may gain customers 154.

Furthermore, if the user 100B posts the photo 106 on another storefront window 104A and adds a link 112 to the photo 106 then the user 1006 may participate in a plurality of games 162.

In FIG. 8 the user 100C is holding a personal mobile device 114 and he is smiling. Also, there is a male friend 108A holding a mobile device 114 and a female friend 110A holding a mobile device 114. If the user 100C posts a photograph 106 which, in this embodiment depicts the female friend 110A, on a storefront window 104 then the photo 106 may now be used as a plurality of gifs, or complimentary items 1568.

When there are a multitude of users utilizing our website 136 then our website 136 or our social network 130 may enable a plurality of information sharing 162.

Furthermore, if the shared information 162 on our website 136 deals with a plurality of thrift 160 then the user 100C may achieve thrift 160.

When the photo 106 is posted on the window 104 or at our website 136 then the photo 106 or the user 100C or the window 104 or the store 102 may gain a plurality of exposure 164.

Also, the user 100C may send a plurality of digital links 112A from their webpage 134 at our website 136 to any personal mobile device 114 or internet network or wireless communication network 138.

### Operation—FIGS. 1-8

Humans enjoy socializing and they seek out social networks to join or become a user of. Also, many humans pass by a multitude of stores on a daily basis. We will now discuss methods used to develop our social network 130 or our website 136.

We believe there are many humans that would like to post a photograph that depicts them on a storefront window or any place where a multitude of other humans may see the photo. We believe this because many humans already post photos that depict them on places where a multitude of other humans may see the photo. In the prior art, these places are usually websites or social networking sites.

In an embodiment of our social network 130, a user 100 passes by a plurality of stores 102 and 102A. A user 100A may develop a plurality of communication 116 with a consenter 122 (or a store manager or a store employee) in order to ask for and then receive a plurality of consent 118. The consent 118 may allow the user 100A to post a photograph 106 on a storefront window 104. The photograph 106 may be framed. The photo 106 may depict the user 100A or any content the user 100A chooses to display. The size of the photo 106 may be determined by the user 100A. Then, a user 100C may receive a user profile (not shown) at our website 136, using methods familiar to humans having ordinary skill in the art. Then, the user 100C may receive a webpage 134 at our website 136. Our website 136 may be behind a firewall (not shown) and may connect to a plurality of internet networks or wireless communication networks 138. The internet networks or wireless communication networks 138 may be selected from the group comprising of gateways, routers, bridges, switches, a web server which includes a memory, web browsers, proxy servers, webpages, websites, game systems, mobile applications, virtual machinery, cloud technology, cellular networks, Wi-fi, Wi-Gig, Li-Fi, local area networks, wide area networks, wireless personal area networks, internet, or intranet.

To create a link 112, the user 100C may copy a uniform resource locator or URL (not shown) at their webpage 134 at our website 136 and then paste the URL on a conventional quick response code generator website (not shown). The quick response code may also be called a QR code. The QR code generator website will then produce a QR code or the link 112. After receiving the link 112 or QR code with the URL embedded in it, the user 100C may use a conventional printer (not shown) to print an analog version (not shown) of the link 112 or QR code. Then the user 100C may post the analog version of the link 112 or QR code on the photograph 106 or in close proximity to it. When we say close proximity we mean several inches or a few feet. As we declared above, the photo 106 is posted on the storefont window 104.

Then the user 100C may use a personal mobile device 114 to take a photograph (not shown) of the photo 106 or create a digital image file 132 of the photo 106 using methods familiar to humans having ordinary skill in the art. Then the user 100C may upload or post the digital image file 132 on their webpage 134 at our website 136 using methods familiar to humans having ordinary skill in the art.

The personal mobile device 114 may have a plurality of mobile applications (not shown) stored in its memory (not shown) that enable the mobile device 114 to scan the link 112. The user 1000 may download or install the mobile application for free by using methods familiar to humans having ordinary skill in the art. When the user 100C utilizes the personal mobile device 114 to scan the link 112 on the photograph 106, then a plurality of content (not shown) from our website 136 may be displayed on the personal mobile device's 114 screen; this is accomplished using conventional methods used with internet networks or wireless communication networks 138.

Furthermore, after developing communication 116 with the consenter 122 or receiving consent 118 or posting the photo 106 on the window 104, the user 100B may now develop a plurality of trust 124 for the store 102 or the consenter 122. This is because the consenter 122 gave consent 118 to the user 100B to post the photo 106 on the window 104 which may be considered a privilege or an asset. When a human grants a privilege or an asset to another human then the latter human may develop trust 124 for the former human. Also, when two humans develop communication 116 with eachother then trust 124 may now develop between them.

Furthermore, everyday that the photo 106 is posted on the window 104, the user 1006 may now find a multitude of reasons to go inside the store 102 more often than when the user 100B did not have the photo 106 posted on the window 104. When the user 100B goes inside the store 102 then communication 116 between the user 100B and the consenter 122 may now develop. This communication 116 may help the user 100B develop trust 124 for the consenter 122 or the store 102.

Furthermore, when the photo 106 is depicting the user 100B then the user 100B may develop a plurality of affiliation 140 with the store 102 because the photo 106 is posted on the storefront window 104 of the store 102. Many humans will trust someone or something that they are affiliated with.

Furthermore, the user 100B may develop a plurality of pride or self-esteem 128 because the user 100B was successful in accomplishing a multitude of goals. Humans feel pride or self-esteem 128 when they are successful in accomplishing their goals. These goals or accomplishments may be selected from the group comprising of: developing the photograph 106 in analog or digital format or developing communication 116 with the consenter 122 or; obtaining consent 118 from the consenter 122 to post the photo 106 on the window 104 or; receiving a user profile or a webpage 134 at our website 136 or, posting the link 112 on the photo 106 or; posting the photo 106 on the window 104 or; making the photo 106 look aesthetic or; having a multitude of humans see or comment on the photo 106 or; the length of time the photo 106 stays posted on the window 104 or; posting the photo 106 on more than one window 104 or, posting the photo 106 on a store 102 that is famous or popular to many humans or, the digital image file 132 or the photo 106 may be seen as an asset (see below). When a human gains an asset then the human may feel they accomplished a goal. When a human accomplishes a goal then the human achieves or develops pride or self-esteem 128.

Furthermore, a multitude of male humans 148 or a multitude of female humans 150 passing by the store 102 may see the user's 1008 photograph 106 on the storefront window 104 and perceive that the store 102 or the consenter 122 exhibits a plurality of good customer service 126. Humans may perceive that the store 102 or the consenter 122 exhibits good customer service 126 because the consenter 122 was kind enough to allow the user 100B the privilege of posting the photo 106 on the window 104. Also, a multitude of humans may perceive that if the photo 106 depicts them and it is posted on the storefront window 104 then the photo 106 is now an asset (see below). When the user 100B receives an asset from the consenter 122 or the store 102 then the user 100B may now perceive the consenter 122 or the store 102 exhibits good customer service 126. The consent 118 given by the consenter 122 may be perceived as an asset. Also, the good customer service 126 may increase the trust 124 that the user 100 has for the store 102 or the consenter 122 because many humans will trust the store 102 or the consenter 122 more if the store or the consenter 122 exhibits good customer service 126.

The good customer service 126 may enable the store 102 to gain a plurality of customers 154. It is known that humans will do more shopping at a store if the store exhibits good customer service 126. Also, humans will do more shopping at a store if they trust the store or store manager or store employee or the consenter 122. Also, gaining customers 154 may enable the store 102 or the consenter 122 to achieve a plurality of sales 142. This is because a store that gains customers 154 will achieve sales 142.

It is known that when a human trusts a store or store employee or perceives that a store or store employee exhibits good customer service then the human may now buy more products or services from the store or store employee.

Also, the store 102 or the consenter 122 may achieve sales 142 because a male friend 108A or a female friend 110A of the user 100C may see the photo 106 (which depicts the user 100C) posted on the storefront window 104. The friend (108A or 110A) may now want to shop at the store 102 because they perceive that the user 100C has shopped at the store 102 or at least considered shopping at the store 102. The friend (108A or 110A) may also perceive that the store 102 or the consenter 122 is kind, friendly, or has good customer service because they allowed the user 100C to post the photo 106 on the window 104. Therefore, the friend (108A or 110A) may now want to shop at the store 102. They may also perceive that the consenter 122 is a mutual friend and thus, they may now want to shop at the store 102.

The photograph 106 may depict the user 100B wearing an article of clothing (not shown) bought at the store 102. A multitude of male humans 148 or a multitude of female humans 150 who know the user 100B may see the photo 106 posted on the storefront window 104 or on a webpage 134 at our website 136; they may like the article of clothing being worn by the user 100B; now the multitude of male humans 148 or the multitude of female humans 150 may now want to shop at the store 102 and thus, the store 102 may gain customers 154.

It is known that when a human sees their friend do something, they tend to do it also, and if they like it, they will continue to do it. That something may be selected from the group comprising of shopping at a store, attending a service or event, getting a manicure or haircut at a beauty salon, or eating at a restaurant.

Furthermore, if there are two or more users (100C and 100B) utilizing our website 136 then our social network 130 may develop; it is known in the art that many users of a social network are narcissistic or vain. Therefore, the users 100C and 100B may now develop a plurality of narcissism or vanity 156.

If the photo 106 depicts the user 100B and the photo 106 is posted on the window 104 so that a multitude of male humans 148 or a multitude of female humans 150 see the photo 106, then the user 100B may develop narcissism or vanity 166. The user 100B may also post the photo 106 on their webpage 134 at our website 136 so that their friends, or anyone using the internet, may see the photo 106. We believe that if the user 100B is narcissistic then they would enjoy posting a photo that depicts them, on a storefront window whereby a multitude of humans (148 or 150) may see them.

It is known that many narcissists share or post photographs depicting themselves, on social networking sites.

There is much data pointing out that social networking sites are full of narcissists and that a multitude of humans desire to have photographs depicting themselves to be seen by other humans. They desire this because a multitude of humans are narcissistic or vain, or they enjoy socializing and thus, they seek out social networks to join or become a user of. They also desire this because a multitude of humans enjoy sharing information with other humans. The information may be selected from the group comprising of activities they are doing, food they are eating, events they are attending, jewelry or clothing they are wearing, cars they are driving, or their beautiful smile full of straight white teeth. Also, in many social networks, humans are encouraged to share photographs of themselves. It is known that many narcissists enjoy sharing information about themselves because they are self-absorbed.

Furthermore, if there are a multitude of male humans 148 or a multitude of female humans 160 passing by the store 102, they may see the user's 100C photograph 106 posted on the storefront window 104 or; they may see the user's 100C digital image file 132 of the photo 106 posted on the users 100C webpage 134 at our website 136. The user 100C may now achieve a plurality of fame 148 because a multitude of male humans 148 or a multitude of female humans 150 saw the user's 100C photo 106 (at our website 136 or on the window 104). Many humans, especially teenagers or young adults, secretly or openly covet fame 146 for themselves. If they achieve fame then they may consider their fame to be an asset. Also, many narcissistic or vain users of a social network want to achieve fame 146 and use photographs or websites to achieve or develop fame 146 in a multitude of ways. Our website 136 may be connected to internet networks or wireless communication networks 138. Now, a multitude of male humans 148 or a multitude of female humans 150 who use internet networks or wireless communication networks 138 may see the digital image file 132 of the photo 106 or; share information about the user 100C and thus, the user 100C may achieve fame 146.

When there are a multitude of users utilizing our website 136 then our website 136 or our social network 130 may enable a plurality of information sharing 162. It is known in the art that many users of a social network share information 162.

Furthermore, if the sharing of information 162 on our website 136 deals with a plurality of thrift 160 then the user 100C may achieve thrift 160. The user 100C may be considering purchasing a plurality of products or services (not shown) from a multitude of stores; before the user 100C purchases the product or service from the store 102, the user may now utilize the shared information 162 on our website 136. The shared information 162 may inform the user 100C that the product or service is being sold cheaper at another store 102A, and thus, the user 100C may achieve thrift 160.

Furthermore, the shared information 162 may inform the store 102 or the consenter 122 about the user 100C because the user 1000 may share information 162 on our website 136 that may be about the user 100C. Therefore, obtaining or analyzing the shared information 162 may help the store 102 or the consenter 122 understand the user 100C better and thus, provide better services or products for the user 100C.

Furthermore, a multitude of male humans 148 or a multitude of female humans 150 who know the user 100C may now want to see the user's 100C photograph 106 at our website 136 simply because they know the user 100C, or they know the store 102, or storefront window 104 that the user 100C posted the photo 106 on. It is known that when a human sees their friend do something, they tend to do it also, and if they like it, they will continue to do it. That something may be selected from the group comprising of: using a website or webpage to see a friend's photograph or; using a website or webpage to see a stranger's photograph or; using a website or webpage to see a photograph.

Hence, a multitude of male humans 148 or a multitude of female humans 150 may want to become users of our website 136 to see a photo 106. When there are a multitude of users utilizing our website 136 then our website 136 may develop a plurality of web traffic 144. Humans (148 or 150) who see the photo 106 on the window 104, may scan the link 112 on the photo 106 with their personal mobile device 114 and connect to our website 136. If there are a multitude of personal mobile devices 114 connected to or utilizing our website 136, then our website 136 may develop web traffic 144.

It is known in the art that web traffic 144 at a website may also develop a plurality of value (not shown) for that website because of conventional methods used in the group comprising of business, advertising, and the internet.

Furthermore, if the user 100B posts the photograph 106 on another storefront window 104A and adds the link 112 to the photo 106, then the user 100B may now participate in a plurality of games 152. In the game 152, the user 100B may receive a plurality of digital rewards (not shown), or a title such as superstar at their webpage 134 at our website 136. The digital reward or title is a reward for being able to post the photo 106 on two storefront windows (104 and 104A). An embodiment of the digital reward may be a digital star avatar or a digital gold coin avatar.

Furthermore, if the user 100B posts the photo 106 which in this embodiment depicts the user 100B, on the storefront window 104 or 104A or on our website 136, then the user 100B may gain a plurality of exposure 164. This is because a multitude of humans passing by the store 102 may see the photo 106 on the window 104. Also, a multitude of humans who are using internet networks or wireless communication networks 138 may see the photo 106 because the user 100B uploaded or posted the digital image file 132 of the photo 106 to their webpage 134 at our website 136.

Furthermore, when the photo 106 is posted on the window 104 or on our website 136, then the user 100B may develop or gain a plurality of assets 166. The asset 166 may be digital or analog. When the photo 106 is utilized with the methods declared above, then the photo 106 may be the asset 166. For example, the photo 106 may help the user 100C achieve fame 146, whereby fame 146 is also the asset 166. Fame is the asset 166 because fame may help the user 100C achieve a multitude of goals as we declared in the background section above. Also, fame 146 may enable the user 100C to gain a plurality of financial assets (not shown). This is another reason why fame 146 is the asset 166. The photo 106 may help the user 100B achieve pride or self-esteem 128 whereby pride or self-esteem 128 is the asset 166. The photo 106 may help the user 100B develop trust 124 with the consenter 122 whereby trust 124 is the asset 166 because trust enables business to occur. Also, the photo 106 may develop webtraffic 144 at our website 136 whereby webtraffic 144 is the asset 166 because webtraffic 144 at a website increases that website's value. Also, the photo 106 may gain exposure 164 for the user 100C or the store 102 whereby the exposure 164 is the asset 166 because exposure may allow a multitude of humans to see the store 102. When a multitude of humans see the store 102 then the store 102 may now gain customers 154 or achieve sales 142. The photo 106 may also help the user 100C achieve thrift 160 whereby thrift 160 is the asset 166 because the user 100C may now save money when the user 100C shops. The consent 118 may also be the asset 166 because the consent 118 allowed the user 100A to post the photo 106 on the window 104. For many narcissists (not shown), posting the photo 106 on a window 104 is an asset 166 because many narcissists enjoy being seen by a multitude of humans.

The content depicted in the photo 106 may be the asset 166. The content may be selected from the group comprising of: cars, jewelry, houses, boats, clothing, or humans. Many humans post photographs of their assets on websites or social networks because humans enjoy sharing information or socializing.

### ALTERNATIVE EMBODIMENTS

In an alternative to the above embodiment, the consenter 122 may sell their consent 118 to the user 100A; thus, there may be a plurality of selling of consent 120.

An alternative to the photograph 106 may be a plurality of art (not shown), that the user 100C may choose to post on the storefront window 104. The art may be selected from the group comprising of: drawings, paintings, or poems.

In an alternative to the above embodiments, the photograph 106 may range in size from a thumbnail to a billboard.

In an alternative to the above embodiments, the consenter 122, or store manager, or store employee may be the user 100C.

In an alternative to the above embodiments, the photograph 106 may be used as a plurality of gifts or complimentary items 158 (FIG. 8). For it to be used as a complimentary item 158 the user 100C may wish to organize a birthday event (not shown) at a restaurant 102B and also invite some friends. In this current embodiment the user 100C may wish to use the complimentary item 158 as an invitation (not shown). The user 100C may use the personal mobile device 114 to take a photograph 106A at the restaurant 102B and then print the photo 106A using a conventional printer (not shown). The user 100C may then post the photo 106A on the restaurant's 102B storefront window 104B, or upload, or post the digital image file 132 of the photo 106A to their webpage 134 at our website 136. The user 100C may also include a copy of a menu (not shown) on their webpage 134, or in the photo 106A. Then the user 100C may notify the male friend 108A or the female friend 110A by sending a plurality of digital links 112A from their webpage 134 at our website 136 to the male friend's 108A or the female friend's 110A webpage 134 at our website 136 or, to their mobile device 114 or; to internet networks or wireless communication networks 138. Now the male friend 108A or the female friend 110A will be notified about the user's 100C upcoming birthday event at the restaurant 102B because they will see the photo 106A when they use the digital link 112A. They will see the photo 106A when they use the digital link 112A because the digital link 112A will connect their mobile device 114 to our website 136 using conventional methods used with internet networks or wireless communication networks 138. The digital link 112A may be selected from the group comprising of a hyperlink, a quick response code, a barcode, an aztec code, a uniform resource locator, an e-mail, or text message.

In an alternative to the above embodiments, the photograph 106 may be used as a gif 158. For it to be used as a gift 158, the photo 106 may depict a human (not shown) other than the user 100C. Then the user 100C (or the consenter 122) may post photo 106 on the window 104, and say the photo 106 is a gift 158 for that human. Now the human may inherently want to buy more products or services from the store 102 because the consenter 122 (or store manager or store employee) gave the human the gift 168. Also, many narcissists would consider a photo 106 that depicts them and that is posted on a storefront window 104 as a gift 158. They may consider the photo 106 a gift because many humans can now see their photo and narcissists enjoy receiving attention.

Also, the gift 158 may be presented as an award (not shown). The award may be selected from the group comprising of employee of the month award, student of the month award, or most valuable player of the game award.

An alternative to the storefront window 104, may be a fence, a door or a wall (not shown). For example, the user 100C may post the photo 106 on the door or the wall of the store 102.

An alternative to the store 102 may be a plurality of events (not shown). The user 100C may post the photo 106 at the event. For example, the user 100C may post the photo 106 on a door, or a wall, or a window at the event. The event may be selected from the group comprising of birthday, graduation, anniversary, holiday, best friend for life proclamation.

As an alternative to the mobile device 114, the user 100C may use a conventional or digital camera (not shown) to take the photo 106.

In an alternative to the above embodiments, the user 100C may use a plurality of printers (not shown) to print the photograph 106, or the link 112, or a frame (not shown) if the photo 106 is framed. The user 100C may print the photo 106, or the link 112, or the frame, using a plurality of mediums (not shown). The medium may be selected from the group comprising of glossy paper, matte paper, metal, glass, or plastic.

In an alternative to the above embodiments, the user 100C may take the photo 106 (or the digital image file 132) using the personal mobile device 114, and then connect the mobile device 114 to a conventional printer (not shown) using methods familiar to humans having ordinary skill in the art. The user 100C may now print the photo 106 in analog format.

An alternative to the digital image file 132 may be a plurality of digital files (not shown). The digital file may be selected from the group comprising of: digital audio files, digital video files, or digital text files.

In an alternative to the above embodiments, the user 100C may use the personal mobile device 114 to take the photograph 106 (or the digital image file 132) infront of the store 102, near the store 102, or inside of the store 102, and then upload or post the photo 106 to their webpage 134 at our website 136. In this current embodiment, the user 100C did not post the photo 106 on the storefront window 104. However, the store 102, the window 104 or any product or service the store 102 offers, may be depicted in the photo 106. Then the photo 106 may be seen by a multitude of humans at our website 136.

In an alternative to the above embodiments, the user 100C may still receive the user profile or the webpage 134 at our website 136 without posting the photo 106 on the window 104.

In an alternative to the above embodiments, the user 100C may have taken or developed the photo 106 prior to going to the store 102. Also, the photo 106 may have been taken or developed by a human other than the user 100C, but the photo 106 may still depict the user 100C.

1. Our system and methods provides a means for a social network; said social network is comprised of:
(a) a photograph depicting a user or any content that said user chooses; said photograph may be framed; said photograph may be in analog or digital format;
(b) a link; said link may be in analog or digital format; said link may be selected from the group comprising of a hyperlink, a quick response code, a barcode, an aztec code, or a uniform resource locator;
(c) a personal mobile device; said personal mobile device may be selected from the group comprising of smartphones, tablets, or laptops.
(d) a storefront window, a residential window, or a window where said photograph may be posted;
(e) a website;
whereby, said user may communicate with a consenter in order to receive a consent to post said photograph on said storefront window; said consenter may be selected from the group comprising of a store, a store manager, a store employee, an event promoter, a home owner, or a human that owns or rents a space that has said window; then said user may post said photograph on said storefront window; then said user may receive a user profile or a webpage at said website; then said user may receive said link from said website; said link may be in digital format; said user may now embed said link within another link so that said link may be more effective; then said user may use a conventional printer to print said link in analog format; then said user may post said link on said photograph or in close proximity to said photograph; said personal mobile device may have a mobile application that enables said personal mobile device to scan said link; then said user may utilize said personal mobile device to scan said link; then a plurality of content from said website may be displayed on said personal mobile device's screen because said link may connect said personal mobile device to said website; then said user may use said personal mobile device to convert said photograph to a digital image file; now said user may upload, download, or post said digital image file to said webpage at said website; now said user may see said digital image file when they access said webpage at said website; if there are two or more of said users utilizing said system and methods, or said website, then a means for said social network is provided.

2. The social network of claim 1, wherein said photograph or said storefront window now provides a means to develop a plurality of narcissism or vanity.

3. The social network of claim 1, wherein said photograph or said storefront window or said link now provides a means to develop a plurality of communication.

4. The social network of claim 1, wherein said photograph or said storefront window or said website now provides a means to gain a plurality of exposure.

5. The social network of claim 1, wherein said photograph or said website now provides a means to achieve a plurality of affiliation with said storefront window or said store.

6. The social network of claim 1, wherein said photograph or said storefront window or said website now provides a means for a plurality of games.

7. The social network of claim 1, wherein said website or said photograph or said storefront window or said link now provides a means for a plurality of information sharing.

8. The social network of claim 1, wherein said photograph or said storefront window or said link now provides a means to develop a plurality of web traffic.

9. The social network of claim 1, wherein said storefront window or said photograph or said website or said link now provides a means to achieve a plurality of fame.

10. The social network of claim 1, wherein said storefront window or said photograph or said website now provides a means to exhibit a plurality of good customer service.

11. The social network of claim 1, wherein said storefront window or said photograph or said website now provides a means to develop or gain a plurality of assets.

12. The social network of claim 1, wherein said storefront window or said photograph or said website now provides a means to achieve a plurality of sales.

13. The social network of claim 1, wherein said storefront window or said photograph or said website now provides a means to gain a plurality of customers.

14. The social network of claim 1, wherein said storefront window or said photograph now provides a means for a plurality of gifts or complimentary items.

15. The social network of claim 1, wherein said storefront window or said photograph or said website now provides a means to achieve or develop a plurality of pride or self-esteem.

16. The social network of claim 1, wherein said storefront window or said photograph now provides a means to develop a plurality of trust.

17. The social network of claim 1, wherein said website or said photograph or said storefront window now provides a means to achieve a plurality of thrift.

18. A social network comprising of: a link; wherein said link is in analog or digital format and connects a personal mobile device to a website when said link is scanned by said personal mobile device; then a user may utilize said personal mobile device to scan said link; now a plurality of content from said website will be displayed on said personal mobile device's screen; whereby, when there are two or more of said users utilizing said website, then said social network will be provided.

19. The social network of claim 18, further including a photograph; wherein said photograph is placed in close proximity or added to said link.

20. The social network of claim 18, further including a storefront window or a window, wherein said link and said photograph may be posted on said storefront window or said window.
